(19) United States
(12) Patent Application Publication
(10) Pub. No.: US 2012/0258274 A1
(43) Pub. Date: Oct. 11, 2012

(54) Disposable moisture proof absorbent/anti-microbial covers for hand grips and seats for gym and exercise equipment

(76) Inventor: Jennifer Del Sole, Larchmont, NY (US)

(21) Appl. No.: 13/506,133

(22) Filed: Mar. 29, 2012

Related U.S. Application Data
(60) Provisional application No. 61/516,617, filed on Apr. 6, 2011.

(51) Int. Cl. B32B 3/02; B32B 3/06

(52) U.S. Cl. 428/81; 428/99

(57) ABSTRACT

Gym and exercise equipment are used on daily basis by a multitude of individuals throughout the course of the day. This equipment can, and does, become contaminated with bodily fluids containing germs, viruses and bacteria from the individuals using the equipment. It would not be conceivable or cost effective for the operators of these gyms to shut the equipment down so the equipment can be cleaned between users.

This invention is a simple, cost effective way of preventing cross contamination amongst users of gym and exercise equipment with regard to the hand grips and seats.

### CROSS-REFERENCE TO RELATED APPLICATIONS

This application is a continuation in part of Ser. No. 61/516,617 filed Apr. 6, 2011

### STATEMENT REGARDING FEDERALLY SPONSORED RESEARCH OR DEVELOPMENT

Research and development of the present invention and application have not been Federally sponsored, and no rights are given under any Federal program.

### REFERENCE TO A MICROFICHE APPENDIX

Not applicable

### BACKGROUND

1. Field of Invention

This invention relates to a means of insulating an operator of exercise and gym equipment mainly the hand grips and seat from coming into contact with bodily fluids that are excreted and secreted from the body and may contain germs, viruses and bacteria from previous operators of the same equipment and to prevent the current operator from contaminating the equipment thereby preventing cross contamination.

2. Description of the Related Art Including Information Disclosed Under 37 CFR 1.97-1.98

The present invention utilizes multi-layer disposable sanitary covers made of moisture proof, absorbent/anti-microbial materials used to insulate gym and exercise equipment, minimizing the spread of germs, viruses, and bacteria between users. These covers can be attached to the hand grips and seat cushions of exercise and gym equipment and secured in place with either an elasticized band or an adhesive strip which is part of the covers. When an individual exercises, the body secretes bodily fluids through sweat glands which is a normal body function. These fluids can contain all types of bacteria and germs which can contaminate the exercise equipment for the next operator. Gym and exercise equipment is not always washed or cleaned between different operators use. Cleaning becomes the operator's responsibility.

A present means of attempting to control this type of contamination caused by these fluids germs, viruses and bacteria is for the operator to use a wiping cloth which contains alcohol or another type of anti-bacterial ingredient, or a paper towel and spray bottle of disinfectant to wipe down the hand grips and seat. This method does not provide complete protection for the new operator from exposing themselves to the contamination left by the previous operator on the hand grips and seat cushion, thus exposing them to these bodily fluids which may contain germs, viruses and bacteria and pose a health risk.

### SUMMARY OF THE INVENTION

This present invention provides a cost effective means of minimizing cross contamination by individuals who use gym and exercise equipment. The disposable hand grip and seat covers are moisture proof, absorbent and anti-microbial. The covers contain multiple layers of material and incorporate an elasticized band or adhesive strip to secure the cover to either the hand grips or seat. The moisture barrier material of the cover prevents any bodily fluids of the operator from coming into contact with the gym and exercise equipment's hand grips and seat while exercising. The absorbent/anti-microbial layer performs two functions. One, it captures and contains the excreted body fluids from the hands, buttocks and groin areas and two, helps inhibit the growth of germs, viruses and bacteria providing an extra layer of protection for the operator. The anti-microbial barrier also helps protect the operator from contracting any bacteria which may be left on the hand grips and seat from the previous operator while securing the covers to the hand grips and seat of the gym and exercise equipment. Prior to using the gym and exercise equipment the operator secures the covers to the hand grips. The covers are secured with either an elasticized band or adhesive strip, depending on the type of hand grip. The elasticized band or adhesive strip is part of the hand grip cover. The seat cover is also placed over the seat prior to use and secured in place. It is secured with either an elasticized band or adhesive strip, depending on the type of seat. The elasticized band or adhesive strip is part of the seat cover. When the operator has finished using the gym and exercise equipment, they remove the covers from the hand grips and seat, and dispose of them in a proper receptacle. This prevents the gym and exercise equipment from becoming contaminated for the next operator, minimizing cross contamination.

### BRIEF DESCRIPTION OF THE DRAWINGS

The above and other objects and advantages of this invention may be more clearly seen when viewed in conjunction with the accompanying drawings wherein:

FIG. 1 shows a view of a typical hand grip used on some gym and exercise equipment;

FIG. 2 shows a view of another type of hand grip used on some gym and exercise equipment;

FIG. 3 shows a view of a typical seat used on gym and exercise equipment;

FIG. 4 shows a cutaway view of the multi-layer design material with the moisture barrier and the absorbent/anti-microbial layers;

FIG. 5 shows a view of the disposable moisture proof absorbent/anti-microbial cover for the hand grips and the elasticized band used to secure it to one type of hand grip used for exercise and gym equipment;

FIG. 6 shows a view of the disposable moisture proof absorbent/anti-microbial hand grip cover with the elasticized band partially in place prior to fully encapsulating the hand grip used on some types of gym and exercise equipment;

FIG. 7 shows a view of the disposable moisture proof absorbent/anti-microbial cover with the adhesive strip used to secure it to the hand grips on a different type of hand grip used on gym and exercise equipment;

FIG. 8 shows a view of the disposable moisture proof anti-microbial cover for the seat and the elasticized band used to secure it to the seat of the typical gym and exercise equipment;

FIG. 9 shows a cutaway view of the disposable moisture proof anti-microbial cover as it would look in place on a typical seat used for gym and exercise equipment.

### DETAILED DESCRIPTION OF THE INVENTION

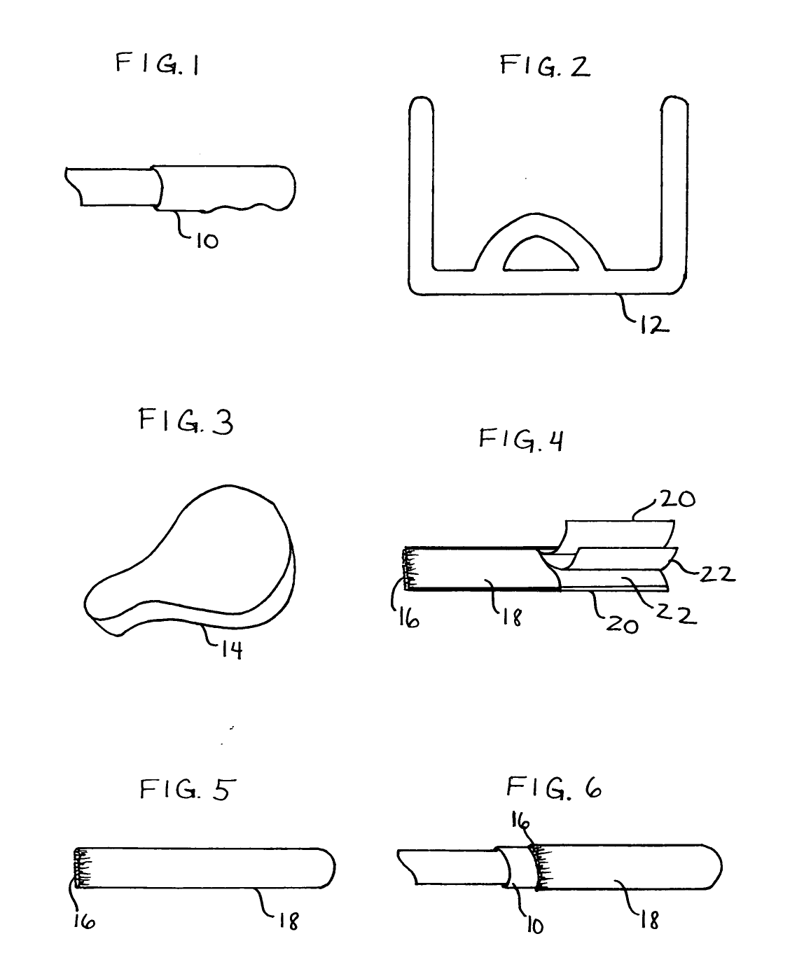

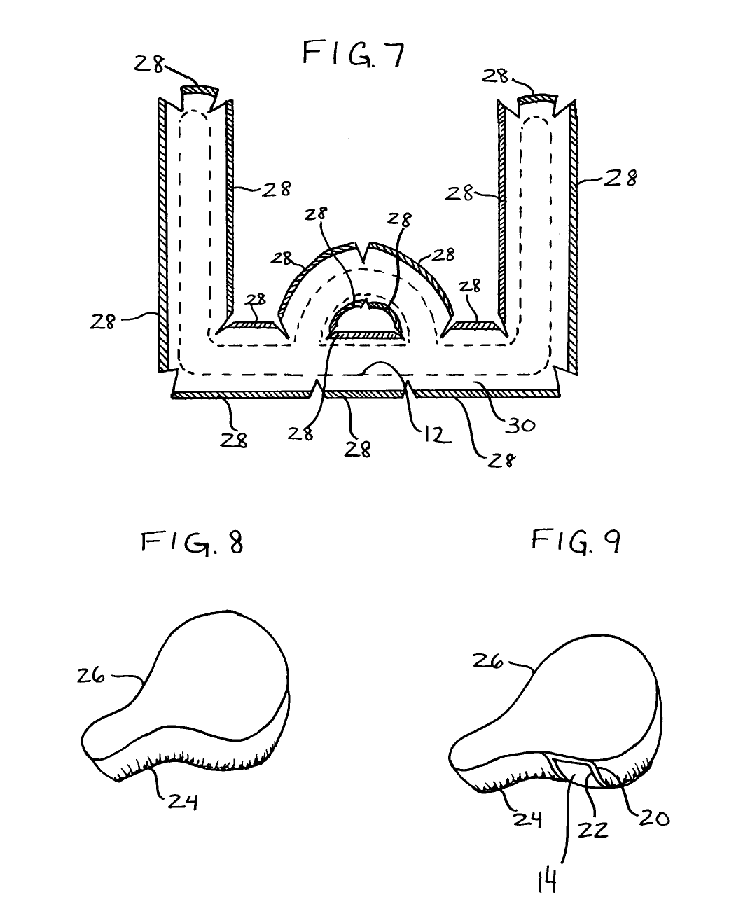

Referring now to FIG. 1 of the drawing which shows one type of hand grip 10, used on exercise and gym equipment. FIG. 2 shows a different type hand grip design 12, used on some types of gym and exercise equipment FIG. 3 shows a seat 14, used on gym and exercise equipment. FIG. 4 shows a cutaway view of the hand grip cover 18, exposing the moisture proof layer 22, and the absorbent/anti-microbial layer 20, of the cover 18, with the elasticized securing band 16, in place on the cover 18. FIG. 5 shows a view of the cover 18, with the elasticized securing band 16, attached. FIG. 6 shows a view of the hand grip cover 18, partially in place on the hand grip 10, prior to fully encapsulating the hand grip 10, and being secured in place with the elasticized band 16. FIG. 7 shows a hidden view of a hand grip 12, used on some types of gym and exercise equipment with the moisture proof absorbent/anti-microbial cover 30, over the hand grip 12, and the adhesive strip 28, used to secure the two parts of the cover 30, together around the hand grip 12. FIG. 8 shows the moisture proof absorbent/anti-microbial cover 26, with the elasticized band 24, in place on the cover 26. FIG. 9 shows a cutaway view of moisture proof, absorbent/anti-microbial seat cover 26, exposing the moisture proof layer 22, and the absorbent/anti-microbial layer 20, over the seat 14, secured in place with the elasticized band 24.

While the invention has been explained by a detailed description of certain specific embodiments, it is understood that various modifications and substitutions can be made in any of them within the scope of the appended claims, which are intended also to include equivalents of such embodiments.

What is claimed is:

1. A disposable multi-layer moisture proof, absorbent/anti-bacterial cover with an elasticized band or adhesive strip for securing the covers to the hand grips and seats used on gym and exercise equipment to prevent cross contamination of bodily fluids containing germs, bacteria and viruses amongst the operators of this type of gym and exercise equipment:

2. The closure of claim 1 wherein the seat covers are moisture proof.

3. The closure of claim 1 wherein the seat covers are absorbent.

4. The closure of claim 1 wherein the seat covers have anti-microbial qualities.

5. The closure of claim 1 wherein the seat covers are disposable.

6. The closure of claim 1 wherein the seat covers have an elasticized band to fit a variety of size seats.

7. The closure of claim 1 wherein the seat covers can be made in a variety of colors.

8. The closure of claim 1 wherein the hand grip covers are sold as single use packaging.

9. The closure of claim 1 wherein the hand grip covers are moisture proof.

10. The closure of claim 1 wherein the hand grip covers are absorbent.

11. The closure of claim 1 wherein the hand grip covers have anti-microbial qualities.

12. The closure of claim 1 wherein the hand grip covers are disposable.

13. The closure of claim 1 wherein the hand grip covers have an elasticized band to fit a variety of size hand grips.

14. The closure of claim 1 wherein the hand grip covers have an adhesive strip to fit a variety of size hand grips.

15. The closure of claim 1 wherein the hand grip covers can be made in a variety of colors.

16. The closure of claim 1 wherein the seat covers are sold as single use packaging.
